(19) United States
(12) Patent Application Publication
(10) Pub. No.: US 2015/0165605 A1
(43) Pub. Date: Jun. 18, 2015

(54) UNIVERSAL CONNECTOR UNIT

(71) Applicant: Shwu-Ruu Chern, Taichung (TW)

(72) Inventor: Shwu-Ruu Chern, Taichung (TW)

(21) Appl. No.: 14/109,998

(22) Filed: Dec. 18, 2013

(51) Int. Cl. B25B 23/00

(52) U.S. Cl. CPC B25B 23/0035

(57) ABSTRACT

A universal connector unit includes a resilient member, a positioning member, a connector and a socket. The connector has a substantially hexagonal head and a substantially rectangular connection portion, and the positioning member is connected to one side of the connector. The socket has a first recess and a second recess, and a shoulder is located between the first and second recesses. The head of the connector is located in the first recess, and the resilient member is biased between the head and the shoulder in the first recess. The positioning member is located in the socket and restricts the head of the connector from dropping out from the socket.

### FIELD OF THE INVENTION

The present invention relates to a universal connector unit, and more particularly, to a universal connector unit firmly connected to the socket and providing high torque.

### BACKGROUND OF THE INVENTION

The conventional universal connector unit is disclosed in FIGS. 11 and 12, and generally comprises a socket 70, a connector 80 having a spherical head 81 and a spring 90, wherein the spherical head 81 is accommodated in the socket 70 and a the spring 90 is located between the spherical head 81 and the socket 70. A pin 82 extends through the spherical head 81 and positions the spherical head 81 in the socket 70. The connector 80 is able to be pivoted about the pin 82.

However, the installation of the pin 82 extending through the spherical head 81 to position the spherical head 81 in the socket 70 involves complicated steps and requires a lot of assembling time. Besides, the spherical head 81 is easily worn out after frequent use, so that the life of use is shortened. The torque is also affected and needs to be improved.

The present invention intends to provide a universal connector unit which improves the shortcomings mentioned above.

### SUMMARY OF THE INVENTION

The present invention relates to a universal connector unit and comprises a resilient member, a positioning member, a connector and a socket. The connector has a substantially hexagonal head and a substantially rectangular connection portion, and the positioning member is connected to one side of the connector. The socket has a first recess and a second recess, and a shoulder is located between the first and second recesses. The head of the connector is located in the first recess, and the resilient member is biased between the head and the shoulder in the first recess. The positioning member is located in the socket and restricts the head of the connector from dropping out from the socket.

Preferably, the resilient member is a scroll spring.

Preferably, the positioning member is a C-clip and the socket has a notch defined in the inside thereof. The C-clip is engaged with the notch.

Preferably, the positioning member is a pin and the socket has at least one positioning hole defined therethrough. The pin extends through the at least one positioning hole.

Preferably, the positioning member comprises a spring and a bead.

Preferably, the first recess is a hexagonal recess.

Preferably, the second recess is a rectangular recess.

The primary object of the present invention is to provide a universal connector unit wherein the parts of the unit are securely connected to each other and can provide high torque.

Another object of the present invention is to provide a universal connector unit wherein the parts of the unit have longer life and do not easily worn out.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the universal connector unit of the present invention;

FIG. 2 is another exploded view to show the universal connector unit of the present invention;

FIG. 3 is a perspective view to show the universal connector unit of the present invention;

FIG. 4 is a cross sectional view of the universal connector unit of the present invention;

FIG. 5 shows the cross sectional view of the connector of the universal connector unit of the present invention;

FIG. 6 is a cross sectional view of the universal connector unit of the present invention;

FIG. 7 is a cross sectional view, taken along line 7-7 in FIG. 6 of the universal connector unit of the present invention;

FIG. 8 shows the pivotal action of the connector of the universal connector unit of the present invention;

FIG. 9 is an exploded view to show another embodiment of the universal connector unit of the present invention;

FIG. 10 is an exploded view to show the universal connector unit of the present invention wherein another socket is connected with the connector;

FIG. 11 is a cross sectional view to show the conventional universal connector unit, and

FIG. 12 is a cross sectional view, taken along line 12-12 in FIG. 11.

### DETAILED DESCRIPTION OF THE PREFERRED EMBODIMENT

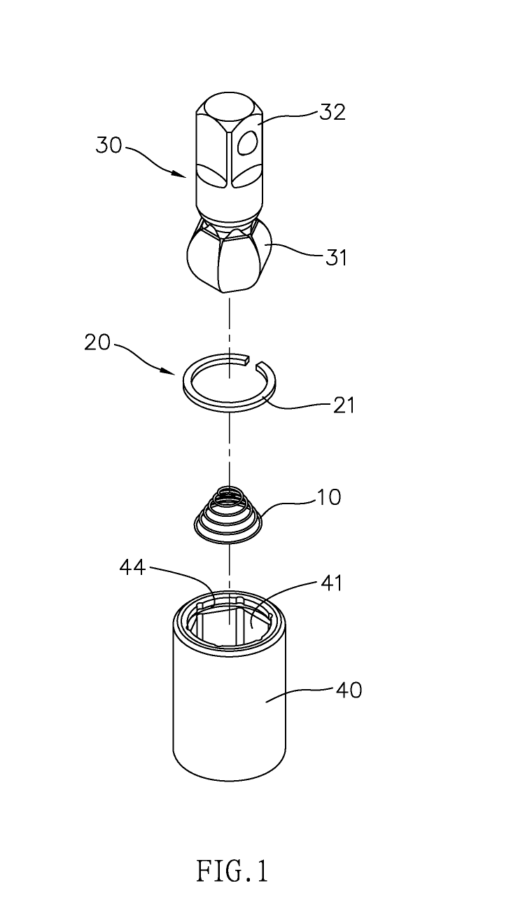

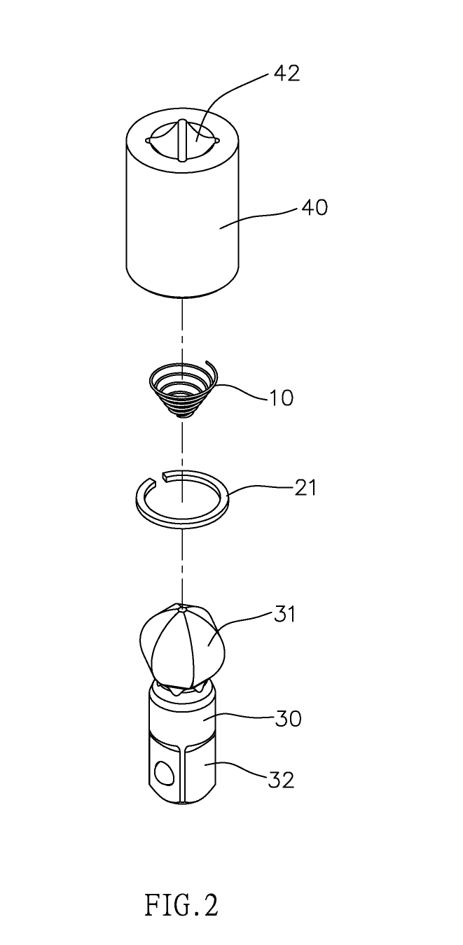

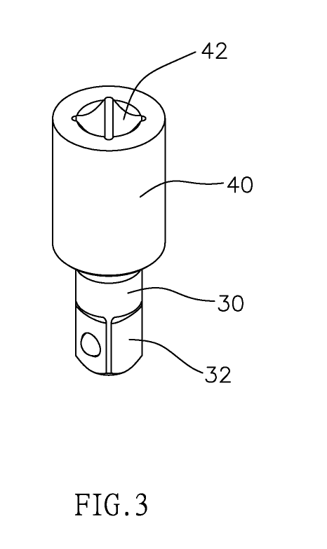

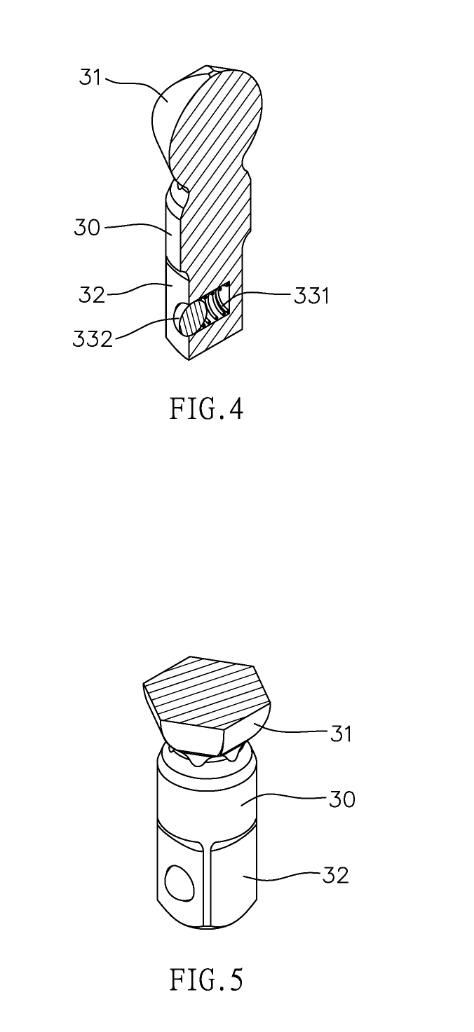

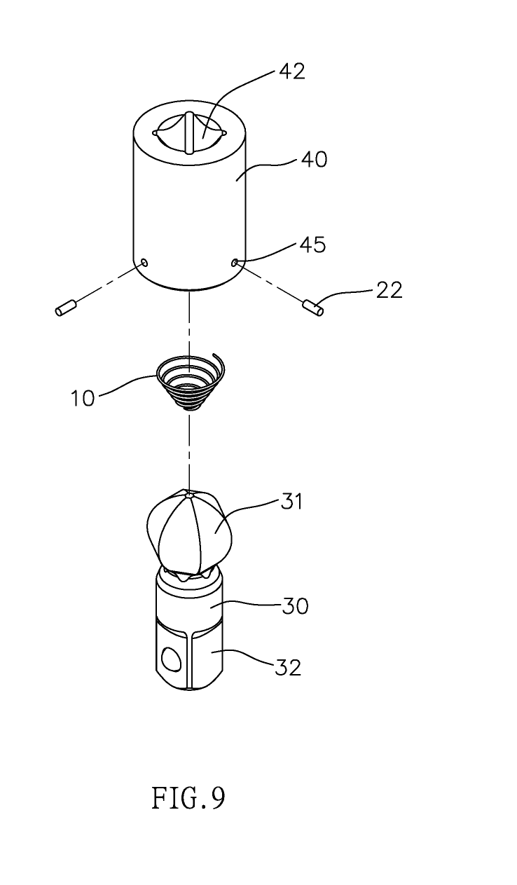

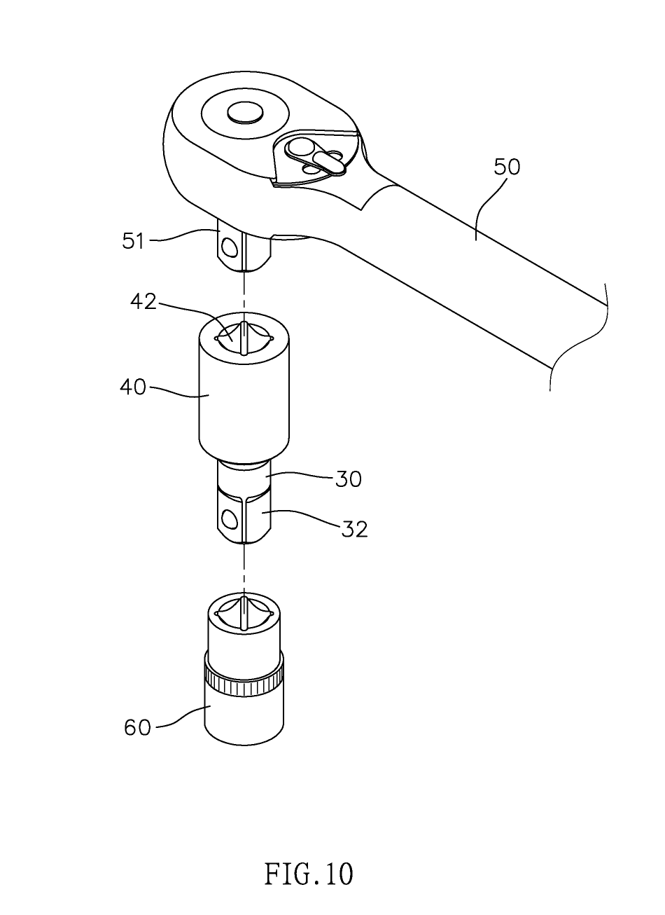

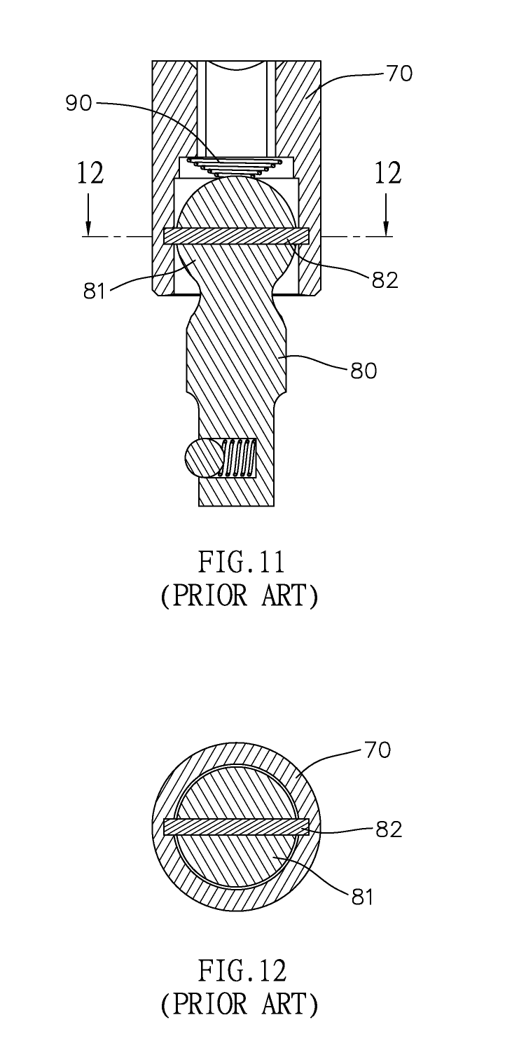

Referring to FIGS. 1 to 10, the universal connector unit of the present invention comprises a resilient member 10, a positioning member 20, a connector 30 and a socket 40. The connector 30 has a substantially hexagonal head 31 and a substantially rectangular connection portion 32. A positioning member 33 is connected to one side of the connector 30. In this embodiment, the positioning member 20 comprises a spring 331 and a bead 332.

The socket 40 has a first recess 41 and a second recess 42 respectively defined in two ends thereof. A shoulder 43 is located between the first and second recesses 41, 42. The head 31 of the connector 30 is located in the first recess 41. The resilient member 10 is biased between the head 31 and the shoulder 43 in the first recess 41. The positioning member 20 is located in the socket 40 and restricts the head 31 of the connector 30 from dropping out from the socket 40.

In this embodiment, the resilient member 10 is a scroll spring. The positioning member 20 is a C-clip 21 and the socket 40 has a notch 44 defined in the inside thereof. The C-clip 21 is engaged with the notch 44 to restrict the head 31 of the connector 30 from dropping out from the socket 40.

Alternatively, the positioning member 20 can be a pin 22 and the socket 40 has at least one positioning hole 45 defined therethrough. The pin 22 extends through the at least one positioning hole 45 to restrict the head 31 of the connector 30 from dropping out from the socket 40.

It is noted that the first recess 41 is a hexagonal recess and the second recess 42 is a rectangular recess.

When in use, the operation portion 51 of the hand tool 50 is inserted into the second recess 42 of the socket 40, and the connection portion 32 of the connector 30 is connected with another socket 60. The socket 60 is mounted to a bolt head and the socket 60 is rotated by rotating the hand tool 50 to tighten or loosen the bolt.

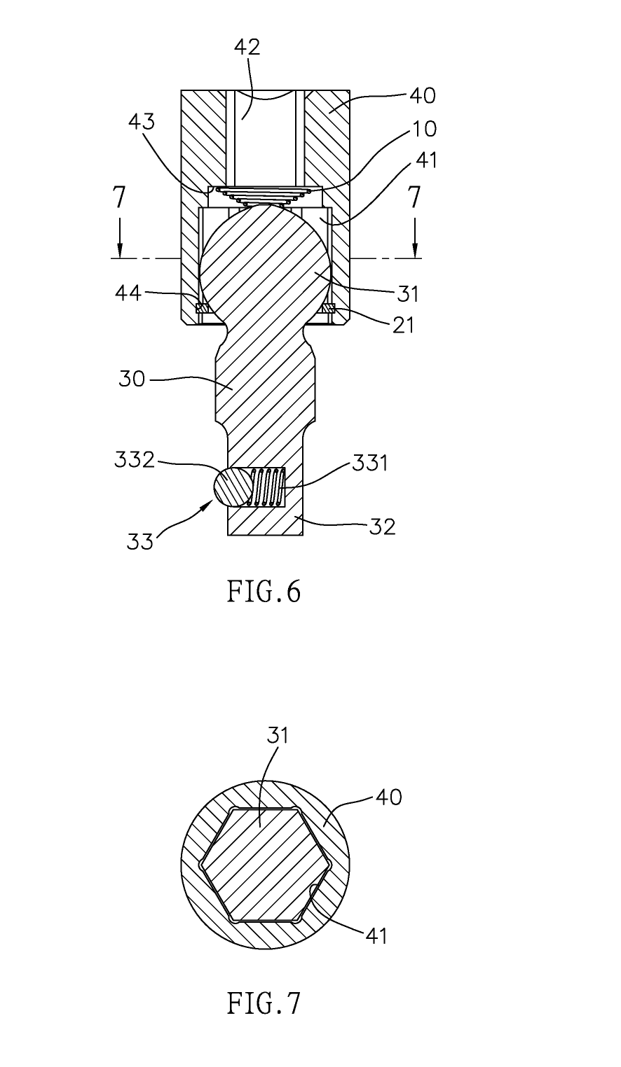

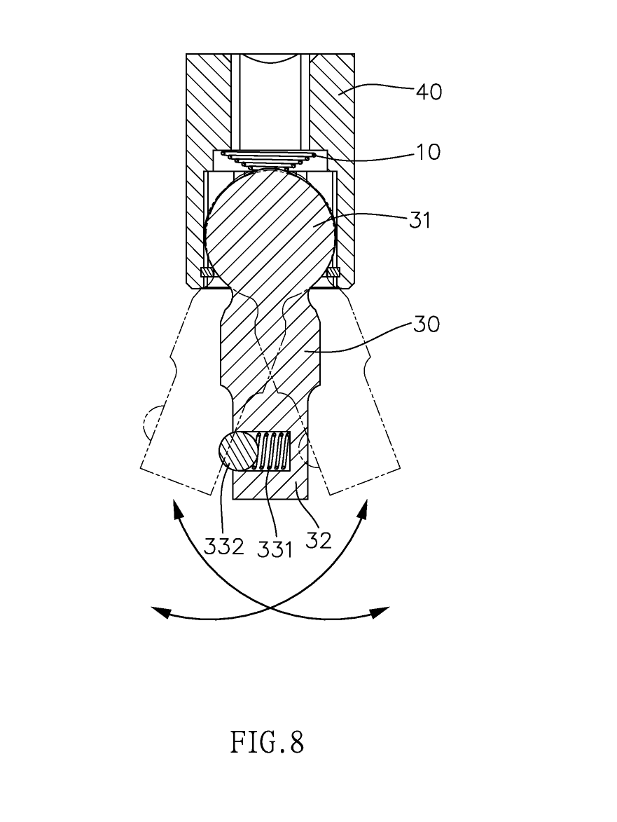

Because the head 31 of the connector 30 is a hexagonal head so that when the head 31 is inserted in the hexagonal first recess 41 of the socket 40, the head 31 of the connector 30 is easily and securely engaged with the first recess 41 as shown in FIGS. 6 and 7. Therefore, a high torque can be output. The connector 30 can be pivoted to a desired angle as shown in FIG. 8, so that the head 31 of the connector 30 is not easily worn out and has a longer life of use.

While we have shown and described the emodiment in accordance with the present invention, it should be clear to those skilled in the art that further embodiments may be made without departing from the scope of the present invention.

What is claimed is:

1. A universal connector unit comprising:
a resilient member;
a positioning member;
a connector having a substantially hexagonal head and a substantially rectangular connection portion, a positioning member connected to one side of the connector, and
a socket having a first recess and a second recess, a shoulder located between the first and second recesses, the head of the connector located in the first recess, the resilient member biased between the head and the shoulder in the first recess, the positioning member located in the socket and restricting the head of the connector from dropping out from the socket.

2. The universal connector unit as claimed in claim 1, wherein the resilient member is a scroll spring.

3. The universal connector unit as claimed in claim 1, wherein the positioning member is a C-clip and the socket has a notch defined in an inside thereof, the C-clip is engaged with the notch.

4. The universal connector unit as claimed in claim 1, wherein the positioning member is a pin and the socket has at least one positioning hole defined therethrough, the pin extends through the at least one positioning hole.

5. The universal connector unit as claimed in claim 1, wherein the positioning member comprises a spring and a bead.

6. The universal connector unit as claimed in claim 1, wherein the first recess is a hexagonal recess.

7. The universal connector unit as claimed in claim 1, wherein the second recess is a rectangular recess.
